(19) United States
(12) Patent Application Publication
(10) Pub. No.: US 2019/0361467 A1
(43) Pub. Date: Nov. 28, 2019

(54) CONTROL PARAMETER ADJUSTMENT APPARATUS

(71) Applicant: Mitsubishi Electric Corporation, Chiyoda-ku (JP)

(72) Inventors: Tomoya FUJITA, Tokyo (JP); Goh SATO, Tokyo (JP); Masayuki UEMATSU, Tokyo (JP); Masahiro OZAWA, Tokyo (JP); Toshiaki KIMATA, Tokyo (JP); Yukihiro IUCHI, Tokyo (JP)

(73) Assignee: Mitsubishi Electric Corporation, Chiyoda-ku (JP)

(21) Appl. No.: 15/759,300

(22) PCT Filed: May 15, 2017
(86) PCT No.: PCT/JP2017/018226

§ 371 Date: Mar. 12, 2018

(51) Int. Cl. G05D 3/20

(52) U.S. Cl. CPC G05D 3/20

(57) ABSTRACT

A control parameter adjustment apparatus that adjusts control parameters of a servo control unit and a command-value generation unit that control a machine apparatus including a drive shaft includes a parameter input unit to receive an input of a design parameter that characterizes a property of the machine apparatus, an adjustment function selection unit to select a control parameter to be adjusted from control parameters that correspond to functions of the servo control unit and the command-value generation unit on the basis of the received design parameter, and an adjustment execution unit to execute adjustment of the control parameter selected by the adjustment function selection unit.

### FIELD

The present invention relates to a control parameter adjustment apparatus that adjusts a control parameter for use in control of a machine apparatus, such as a numerical control machine tool, an industrial machine, a robot, or a transfer machine.

### BACKGROUND

In a numerically controlled machine apparatus, a servomotor and other actuators are controlled in such a manner that a tool, a workpiece, a hand, or the like to be controlled follows command values of a position, a path, a speed, a force, and the like that are programmed. Examples of the numerically controlled machine apparatus include a numerical control machine tool, an industrial machine, a robot, a transfer machine, and other numerical control apparatuses. Some machine apparatuses are numerically controlled by a control apparatus, such as a programmable logic controller (PLC), a robot controller, and a servo control apparatus. A numerically controlled machine apparatus is hereinafter referred to simply as a machine apparatus.

There are various error factors and disturbance factors in the machine structure and components of a machine apparatus. To enable a subject that is to be controlled to follow a command value with high accuracy, such errors need to be corrected. An optimal value for a correction quantity may differ due to a difference in structure of machine apparatuses, an individual difference in a machine apparatus, and the like. Generally, a control parameter is provided to adjust the correction quantity. By adjusting control parameters, control can be achieved that enables various types of machine apparatus to follow command values with high accuracy.

It takes time and effort for an operator to set such control parameters, and acquiring the skill for setting the control parameters appropriately is time-consuming for an operator. As a solution for this problem, a method is disclosed in, for example, Patent Literature 1 in which a servo control apparatus that corrects a motion error caused under the influence of friction determines an optimal parameter by repeating correction of a torque command and update of a corrected torque until a response error caused during an arc motion when a parameter is changed becomes equal to or less than a threshold value.

### CITATION LIST

### Patent Literature

Patent Literature 1: Japanese Patent Application Laid-open No. H11-24754

### SUMMARY

### Technical Problem

Known correction functions to correct an error in a machine apparatus include a function to correct a motion error caused under the influence of friction, a function to adjust an acceleration/deceleration pattern that acts as a factor to cause a vibration in a machine structure, and other functions. The function to correct a motion error caused under the influence of friction is classified into multiple correction functions in accordance with friction models. Generally, one or more control parameters are used to achieve a certain correction function. A machine apparatus may have a function that can be adjusted using a control parameter, in addition to the correction function to correct an error.

A control apparatus that has a plurality of functions poses a challenge of appropriately selecting a function to use in order to achieve target performance. For example, using all the functions may result in degradation in performance because the functions interfere with each other. In another example, a function that is appropriately selected to satisfy performance under certain condition may not be able to achieve the performance under a different condition. Selecting a function from a plurality of functions, that is, selecting which control parameter to adjust, is thus not a simple task, and adjusting a control parameter requires a highly skilled operator as well as time and effort. Additionally, a control parameter that an operator has set may not be appropriate.

In Patent Literature 1 described above, a method of setting a control parameter in a correction function that uses a single friction model is merely disclosed; appropriate selection of a function to use is not disclosed.

The present invention has been achieved in view of the above, and an object of the present invention is to provide a control parameter adjustment apparatus that enables operators including unskilled operators to appropriately set a control parameter to be adjusted in a control apparatus that has a plurality of functions.

### Solution to Problem

To solve the problems described above and achieve the object described above, a control parameter adjustment apparatus according to an aspect of the present invention is a control parameter adjustment apparatus that adjusts a control parameter of a control apparatus that controls a machine apparatus including a drive shaft and includes a receiving unit to receive an input of a design parameter that characterizes a property of the machine apparatus. The control parameter adjustment apparatus according to an aspect of the present invention further includes a selecting unit to select a control parameter to be adjusted from control parameters that correspond to a function of the control apparatus on a basis of the design parameter received by the receiving unit; and an executing unit to execute adjustment of the control parameter selected by the selecting unit.

### Advantageous Effects of Invention

A control parameter adjustment apparatus according to the present invention produces an effect where operators including unskilled operators can appropriately set a control parameter to be adjusted in a control apparatus that has a plurality of functions.

### BRIEF DESCRIPTION OF DRAWINGS

FIG. 1 is a diagram illustrating an exemplary configuration of a control parameter adjustment apparatus according to a first embodiment.

FIG. 2 is a diagram illustrating an exemplary hardware configuration of the control parameter adjustment apparatus according to the first embodiment.

FIG. 3 is a diagram illustrating an example of a machine configuration in a machine apparatus to be controlled by the control parameter adjustment apparatus according to the first embodiment.

FIG. 4 is a diagram illustrating an exemplary configuration of a servo control unit according to the first embodiment.

FIG. 5 is a diagram illustrating an example of an input screen that receives the input of structure parameters Cm in the first embodiment.

FIG. 6 is a diagram illustrating an example of the input screen to which an operator has input the structure parameters Cm that correspond to the machine apparatus illustrated in FIG. 3.

FIG. 7 is a diagram illustrating an example of an input screen that receives the input of drive shaft parameters Cd in the first embodiment.

FIG. 8 is a diagram illustrating an example of the input screen to which an operator has input the drive shaft parameters Cd that correspond to the machine apparatus illustrated in FIG. 3.

FIG. 9 is a flowchart illustrating an example procedure of control parameter selection processing in an adjustment function selection unit according to the first embodiment.

FIG. 10 is a diagram illustrating an example of control parameter selection information according to the first embodiment.

FIG. 11 is a flowchart illustrating an example procedure of control parameter adjustment processing in an adjustment execution unit according to the first embodiment.

FIG. 12 is a diagram illustrating an example of measurement information recorded in step S13 in the first embodiment.

FIG. 13 is a diagram illustrating an example of the measurement information when a control parameter #1 and a control parameter #2 are adjusted together in the first embodiment.

FIG. 14 is a diagram illustrating an example of connection between a control parameter adjustment apparatus according to a second embodiment and a command-value generation unit and the servo control unit.

FIG. 15 is a diagram illustrating an exemplary configuration of a control parameter adjustment apparatus according to a third embodiment.

FIG. 16 is a flowchart illustrating an example procedure of parameter adjustment processing in an adjustment execution unit according to the third embodiment.

FIG. 17 is a diagram illustrating an example of target information in the third embodiment.

FIG. 18 is a diagram illustrating an exemplary configuration of a control parameter adjustment apparatus according to a fourth embodiment.

FIG. 19 is a diagram illustrating an example of information recorded by an adjustment data recording unit according to the fourth embodiment.

FIG. 20 is a diagram illustrating an exemplary configuration of a control parameter adjustment apparatus according to a fifth embodiment.

FIG. 21 is a diagram illustrating an example of component estimation information in the fifth embodiment.

FIG. 22 is a diagram illustrating an exemplary configuration of a control parameter adjustment apparatus according to a sixth embodiment.

### DESCRIPTION OF EMBODIMENTS

A control parameter adjustment apparatus according to embodiments of the present invention described below in detail with reference to the drawings. The present invention is not limited to the embodiments.

### First Embodiment

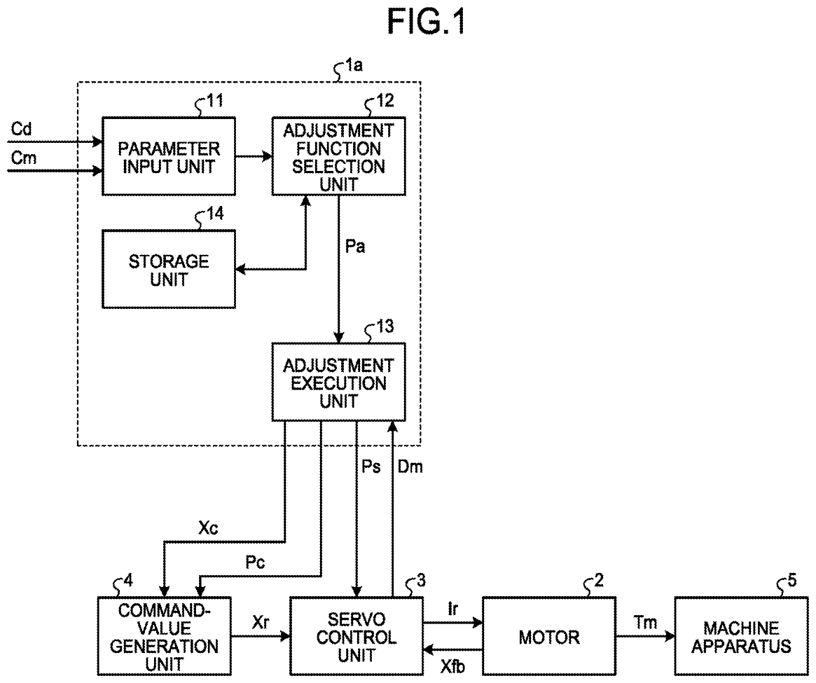

FIG. 1 is a diagram illustrating an exemplary configuration of a control parameter adjustment apparatus according to a first embodiment of the present invention. In FIG. 1, a control parameter adjustment apparatus 1a according to the first embodiment is illustrated along with a servo control unit 3 and a command-value generation unit 4 in which control parameters are set by the control parameter adjustment apparatus 1a, a motor 2 that is controlled by the servo control unit 3, and a machine apparatus 5 that is driven by a rotational torque Tm of the motor 2.

The command-value generation unit 4 generates a position command Xr for the motor 2 and transmits the generated position command Xr to the servo control unit 3. The servo control unit 3 performs feedback control on the basis of the position command Xr and a feedback position Xfb, which is information indicative of the position of the motor 2, and transmits a motor drive current Ir, which is generated in the feedback control, to the motor 2. The command-value generation unit 4 and the servo control unit 3 are examples of a control apparatus that numerically controls the machine apparatus 5 via the motor 2 and has a plurality of functions. The command-value generation unit 4 and the servo control unit 3 may configure one control apparatus.

The motor 2 is an actuator and, specifically, is a rotary motor. The motor 2 is connected to the machine apparatus 5, which is a body to be driven and controlled by the servo control unit 3, which is controlled by the control parameter adjustment apparatus 1a. The motor 2 rotates in accordance with the motor drive current Ir to drive the machine apparatus 5 with the rotational torque Tm.

The command-value generation unit 4 and the servo control unit 3 each have functions that are related to control, such as a function to correct a motion error caused under an influence of friction, a function to adjust an acceleration/deceleration pattern that acts as a factor to cause a vibration in a machine structure, and other correction functions. To achieve each function, a control parameter is adjusted in such a manner that desired performance corresponding to a property or the like of the machine apparatus 5 can be obtained.

The control parameter adjustment apparatus 1a adjusts control parameters of the command-value generation unit 4 and the servo control unit 3, which are the control apparatuses that control the machine apparatus 5, which has a drive shaft. As illustrated in FIG. 1, the control parameter adjustment apparatus 1a includes a parameter input unit 11, an adjustment function selection unit 12, an adjustment execution unit 13, and a storage unit 14. The parameter input unit 11, which is a receiving unit, receives the input of a design parameter that characterizes a property of the machine apparatus 5. The design parameter includes at least one of a structure parameter Cm that characterizes a structure of the machine apparatus 5 and a drive shaft parameter Cd that characterizes components that configure the drive shaft of the machine apparatus 5. The structure parameter Cm and the drive shaft parameter Cd received by the parameter input unit 11 are each hereinafter referred to as an input parameter.

The adjustment function selection unit 12 selects a control parameter to be adjusted from control parameters that correspond to functions achievable by the command-value generation unit 4 and the servo control unit 3 on the basis of a design parameter received by the parameter input unit 11 or the receiving unit, that is, at least one of the structure parameter Cm and the drive shaft parameter Cd. The adjustment function selection unit 12 notifies the adjustment execution unit 13 of a selected control parameter Pa. That is, the adjustment function selection unit 12 is a selecting unit that selects a control parameter to be adjusted from control parameters that correspond to functions of the command-value generation unit 4 and the servo control unit 3 on the basis of the structure parameter Cm and the drive shaft parameter Cd received by the parameter input unit 11, which is the receiving unit. The functions achievable by the command-value generation unit 4 and the servo control unit 3 include any one or more of a first function for which a control parameter is set in only the command-value generation unit 4, a second function for which a control parameter is set in only the servo control unit 3, and a third function for which control parameters need to be set in both the command-value generation unit 4 and the servo control unit 3.

The adjustment execution unit 13 executes adjustment of the control parameter Pa that is selected as a control parameter to be adjusted on the basis of motion information on the machine apparatus received from the servo control unit 3. That is, the adjustment execution unit 13 is an executing unit that executes adjustment of a control parameter that is selected by the adjustment function selection unit 12. The adjustment execution unit 13 transmits the control parameter to at least one of the command-value generation unit 4 and the servo control unit 3 on the basis of the result of the adjustment and transmits an operation program Xc, which is to be described below, to the command-value generation unit 4. The motion information on the machine apparatus 5 is information indicative of the state of the machine apparatus 5, which is, for example, an error Dm, which indicates a difference in the machine apparatus 5 between a command value and the actual state of the machine apparatus 5. The error Dm is, for example, a response error or a speed deviation. The response error is, for example, a quadrant glitch quantity or an overshoot quantity. The motion information on the machine apparatus 5 may be information that enables calculation of an error, in place of an error itself. The motion information on the machine apparatus 5 may be an actual position, an actual speed, a motor drive current, or the like. The storage unit 14 stores control parameter selection information, which is to be described below.

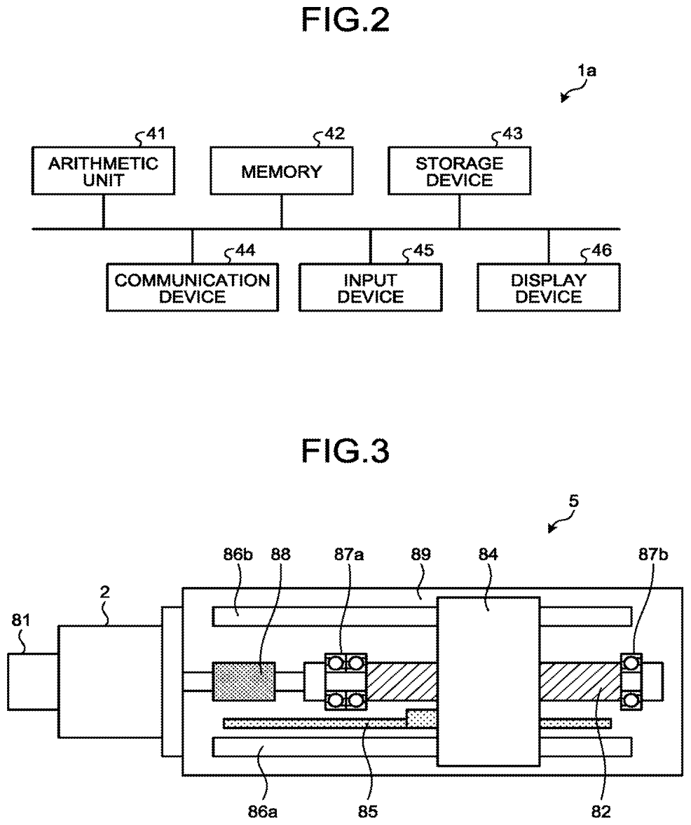

A hardware configuration of the present embodiment is described next. FIG. 2 is a diagram illustrating an exemplary hardware configuration of the control parameter adjustment apparatus 1a according to the first embodiment. The control parameter adjustment apparatus 1a includes an arithmetic unit 41, which is a processor such as a central processing unit (CPU) that performs arithmetic processing; a memory 42 that the arithmetic unit 41 uses as a work area; a storage device 43 that can store a program, information, and the like; a communication device 44 that has a function to communicate with the outside; an input device 45 that receives an input from an operator; and a display device 46. The input device 45 is exemplified by a keyboard and a mouse, and the display device 46 is exemplified by a monitor and a display. The input device 45 and the display device 46 may be integrated and achieved as a touch panel or the like.

The parameter input unit 11, the adjustment function selection unit 12, and the adjustment execution unit 13 illustrated in FIG. 1 are achieved by the arithmetic unit 41 executing a program stored in the storage device 43. When the parameter input unit 11 is achieved by the arithmetic unit 41, the input device 45 and the display device 46 are used. When the adjustment execution unit 13 is achieved by the arithmetic unit 41, the communication device 44 may be used. The storage unit 14 is achieved with the storage device 43.

FIG. 3 is a diagram illustrating an example of a machine configuration in the machine apparatus 5, which is to be controlled by the control parameter adjustment apparatus 1a according to the first embodiment. The machine apparatus 5 includes a bed 89 that is placed horizontally; a guide mechanism 86a and a guide mechanism 86b that are retained on the bed 89; and a table 84 that is supported by the guide mechanism 86a and the guide mechanism 86b and has a restricted movable direction. The machine apparatus 5 also includes a ball screw 82 to which a movable portion that is configured using an undepicted nut placed on a rear surface of the table 84 and the table 84 is attached and a ball front bearing 87a and a rear bearing 87b that retain the ball screw 82.

The ball screw 82 is coupled to the rotation shaft of the motor 2 via a rigid coupling 88. Here, a single anchor scheme is used as a bearing scheme, where the ball front bearing 87a is retained by an angular contact ball bearing and the rear bearing 87b is supported by a deep groove ball bearing.

The table 84 is supported by the guide mechanism 86a and the guide mechanism 86b, which restrict the motion of the table 84 in a direction other than the movable direction. As used herein, the guide mechanism 86a and the guide mechanism 86b are each a linear motion roiling guide mechanism that has steel balls as rolling elements lubricated with grease.

As illustrated in FIG. 3, a motor position detector 81 is attached to the motor 2. A specific example of the motor position detector 81 is a rotary encoder. A table position detector 85 is included to measure the position of the table 84, which is to be controlled. A specific example of the table position detector 85 is a linear encoder. At least one of the position of the motor 2 detected by the motor position detector 81 and the position of the table detected by the table position detector 85 is input to the servo control unit 3.

The table position detector 85 can measure a moving distance of the table 84, whereas the position directly detected by the motor position detector 81 is a rotary angle of the motor 2. The servo control unit 3 can convert the rotary angle of the motor 2 to the length of the table 84 in a moving direction of the table 84 by multiplying the rotary angle by a ball screw lead that is a table moving distance per rotation of the motor 2 and by dividing the resultant by an angle 2 π[rad] of one motor rotation.

The feedback position Xfb illustrated in FIG. 1 is at least one of the position of the motor 2 detected by the motor position detector 81 and the position of the table detected by the table position detector 85. An example is illustrated in FIG. 1 in which the feedback position Xfb is the motor position detected by the motor position detector 81 on the basis of an assumption that the motor 2 includes the motor position detector 81. The feedback position Xfb in FIG. 1 is provided as an example; the motor position detector 81 does not have to be a component of the motor 2; as described above, the feedback position Xfb may be the table position detected by the table position detector 85.

Feedback control that uses the result of detection by the motor position detector 81 as the feedback position Xfb is referred to as semi-closed loop control. Feedback control that uses the results of detection by both the motor position detector 81 and the table position detector 85 or the result of only the table position detector 85 as the feedback position Xfb is referred to as fully closed loop control.

The configuration of the machine apparatus 5 described above is provided as an example; the configuration of the machine apparatus 5 is not limited to the example illustrated in FIG. 3. As described below, the control parameter adjustment apparatus 1a according to the present embodiment can control a plurality of machine apparatuses 5.

An operation of the command-value generation unit 4 is described next. The command-value generation unit 4 generates the position command Xr for the servo control unit 3 on the basis of the operation program Xc received from the adjustment execution unit 13. As used herein, the operation program Xc is an NC program describing in a G code a command position and a command speed of a subject to be controlled in the machine apparatus 5; the command Xr for the servo control unit 3 includes time-series position commands generated by subjecting the operation program Xc to acceleration/deceleration processing and filtering processing. The G code is one type of instruction code for use in numerical control and is a command code written for performing positioning of a subject to be controlled, linear interpolation, circular interpolation, plane designation, or the like. The NC program is a program for use in the numerical control.

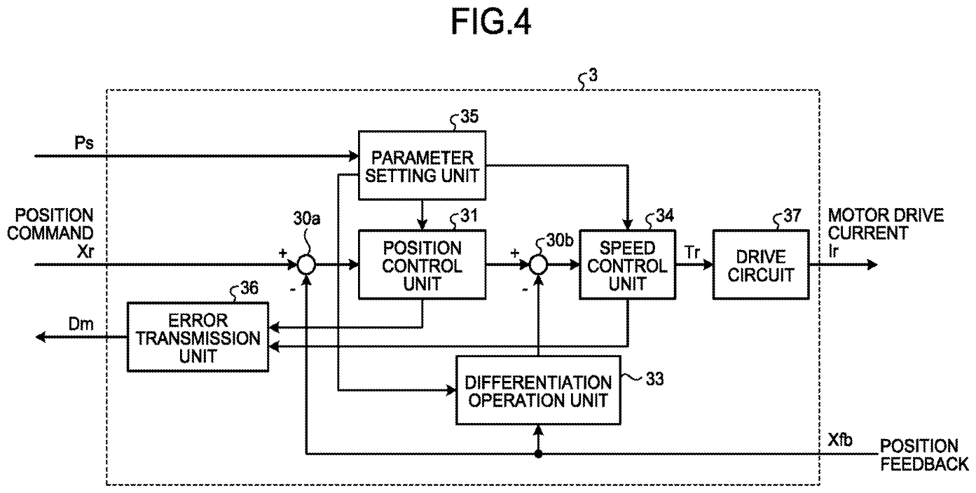

An exemplary configuration and an operation of the servo control unit 3 are described next. FIG. 4 is a diagram illustrating an exemplary configuration of the servo control unit 3 according to the first embodiment. As illustrated in FIG. 4, the servo control unit 3 includes an adder-subtracter unit 30a that obtains a response error, which is a difference between the position command Xr and the feedback position Xfb, which is a response position; a position control unit 31 that receives a deviation obtained by the adder-subtracter unit 30a; and a differentiation operation unit 33 that performs differentiation operation. The servo control unit 3 also includes an adder-subtracter unit 30b that obtains a deviation between a speed command obtained by the position control unit 31 and an actual speed obtained by the differentiation operation unit 33; a speed control unit 34 that outputs a torque command Tr that is a drive command; a parameter setting unit 35 that sets a control parameter Ps received from the control parameter adjustment apparatus 1a in each of corresponding units; an error transmission unit 36 that transmits the error Dm to the control parameter adjustment apparatus 1a; and a drive circuit 37 that outputs the motor drive current Ir on the basis of the torque command Tr.

The adder-subtracter unit 30a obtains a position deviation, which is a deviation between the position command Xr and the feedback position Xfb, and outputs the position deviation to the position control unit 31. The position control unit 31 performs position control processing, such as proportional control, such that the position deviation input from the adder-subtracter unit 30a is reduced and outputs the speed command that reduces the position deviation. The differentiation operation unit 33 obtains a feedback speed resulted from differentiation of the feedback position Xfb. If both the position of the machine apparatus 5 and the position of the motor 2 are used in the fully closed loop control, a detection value of the motor position detector 81 is input to the differentiation operation unit 33 and a detection value of the table position detector 85 is input to the adder-subtracter unit 30a.

The adder-subtracter unit 30b obtains a speed deviation that is a deviation between the speed command obtained by the position control unit 31 and the actual speed obtained by the differentiation operation unit 33 and outputs the speed deviation to the speed control unit 34. The speed control unit 34 performs speed control processing, such as proportional integral control, such that the speed deviation input from the adder-subtracter unit 30b is reduced to calculate the torque command Tr and outputs the torque command Tr to the drive circuit 37. The drive circuit 37 outputs the motor drive current Ir based on the torque command Tr to the motor 2. The operations of the parameter setting unit 35 and the error transmission unit 36 are described hereinafter in detail.

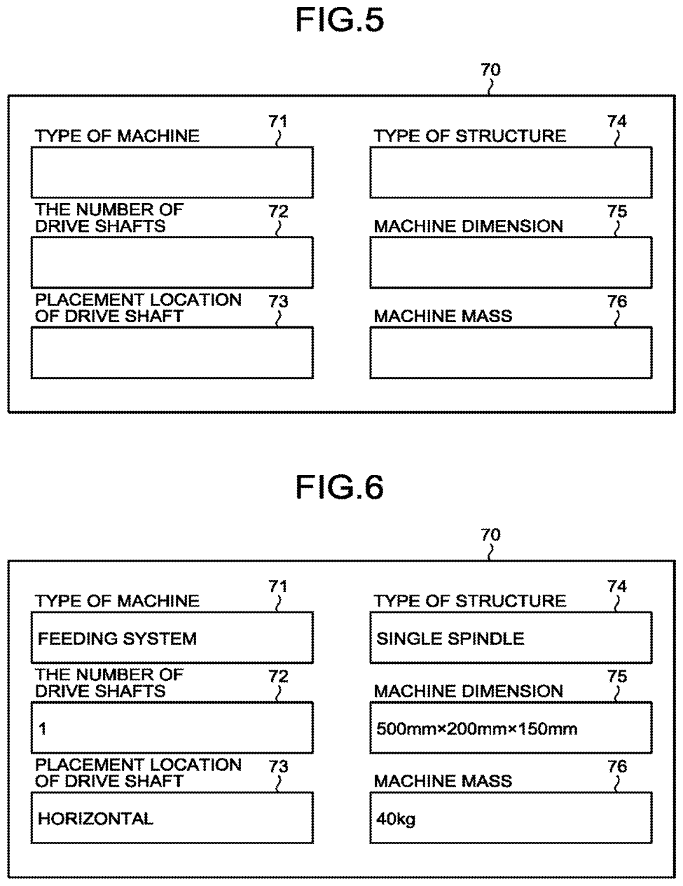

A parameter adjustment method according to the present embodiment is described next. As described above, the parameter input unit 11 receives the input of the structure parameters Cm, which characterize a structure of the machine apparatus 5. FIG. 5 is a diagram illustrating an example of an input screen 70 that receives the input of the structure parameters Cm. The parameter input unit 11 presents the input screen 70 illustrated in FIG. 5 on the display device 46 and waits for an input from an operator. The input screen 70 includes a machine type input field 71 to which the type of machine is input; a drive-shaft number input field 72 to which the number of drive shafts is input; a drive-shaft placement location input field 73 to which the placement location of a drive shaft is input; a structure name input field 74 to which the name of a structure is input; a machine dimension input field 75 to which machine dimensions are input; and a machine mass input field 76 to which machine mass is input. In an example illustrated in FIG. 5, the structure parameters Cm include the type of machine, the number of drive shafts, the placement location of a drive shaft, the name of a structure, the machine dimensions, and the machine mass. The structure parameters Cm illustrated in FIG. 5 are provided as an example; the structure parameters Cm are not limited to the example illustrated in FIG. 5.

The type of the machine apparatus 5, such as a robot, a turning center, a machining center, a transfer machine, and a feeding system, is input to the machine type input field 71. The number of drive shafts included in the machine apparatus 5 is input to the drive-shaft number input field 72. Information indicative of a location where a drive shaft of the machine apparatus 5 is placed, which is, for example, information indicative of the placement location, such as horizontal and vertical, or of a shaft placement, such as a mechanism code X-YZ used in numerical control machine tools, is input to the drive-shaft placement location input field 73. The name of the structure of the machine apparatus 5, such as a C column structure, a horizontal type, a vertical type, a double column type, a horizontal articulated type, a vertical articulated type, a single spindle, or the like, is input to the structure name input field 74.

An operator operates the input device 45 to input a value that corresponds to each of the input fields in the input screen 70 illustrated FIG. 5. The parameter input unit 11 receives information input when the input device 45 is operated and controls the display device 46 to allow the received information to be displayed in corresponding input fields in the input screen 70.

The machine apparatus 5 illustrated in FIG. 3 includes, for example, one drive shaft that is set horizontally. The structure name of the machine apparatus 5 is a single spindle and the type of machine is a feeding system. It is also assumed that the machine apparatus 5 has dimensions of 500 mm×200 mm×150 mm and mass of 40 kg.

FIG. 6 is a diagram illustrating an example of the input screen 70 to which an operator has input the structure parameters Cm that correspond to the machine apparatus 5 illustrated in FIG. 3. As illustrated in FIG. 6, when an operator has input information that corresponds to each of the structure parameters Cm, the parameter input unit 11 presents, on the display device 46, the information.

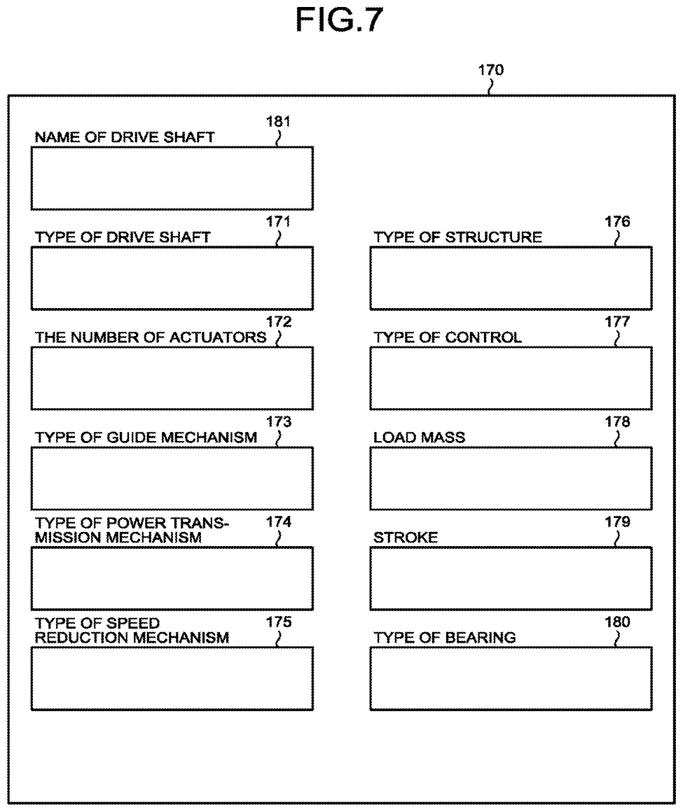

The parameter input unit 11 similarly receives the input of the drive shaft parameters Cd, which characterize components that configure a drive shaft of the machine apparatus 5. FIG. 7 is a diagram illustrating an example of an input screen 170 that receives the input of the drive shaft parameters Cd. The parameter input unit 11 can display multiple input screens 170 equivalent in number to the shafts input to the drive-shaft number input field 72 in the input screen 70. The parameter input unit 11, for example, causes a drive-shaft input field 181 to which the name of a drive shaft is input to function as a selectable field by displaying a pull-down menu. Each pull-down menu presents information that identifies a drive shaft, such as “first shaft:” and “second shaft:”, and a drive shaft can be selected from the pull-down menu. When a drive shaft is selected from the pull-down menu, the drive-shaft input field 181 can accept the name of the drive shaft and the other associated input fields can also accept inputs.

If, for example, the number of shafts input to the drive-shaft number input field 72 in the input screen 70 is one, only the first shaft is displayed; if the number of shafts input to the drive-shaft number input field 72 in the input screen 70 is two, “first shaft:” and “second shaft:” are displayed in a pull-down menu and one of the two can be selected. If “first shaft:” is selected, the parameter input unit 11 receives the input of information that corresponds to the first shaft in the input screen 170; if “second shaft:” is selected, the parameter input unit 11 receives the input of information that corresponds to the second shaft in the input screen 170. In this manner, the parameter input unit 11 presents multiple input screens 170 equivalent in number to the drive shafts. The method of receiving the input of multiple drive shaft parameters Cd equivalent in number to the drive shafts is not limited to this example; multiple input screens 170 equivalent in number to the drive shafts may be displayed simultaneously.

The input screen 170 includes, in addition to the drive-shaft input field 181, a drive-shaft type input field 171 to which the type of drive shaft is input; an actuator number input field 172 to which the number of actuators used for driving the drive shaft is input; a guide-mechanism type input field 173 to which the type of guide mechanism is input; and a power-transmission-mechanism type input field 174 to which a power-transmission-mechanism type is input. The input screen 170 also includes a speed-reduction-mechanism type input field 175 to which the type of speed reduction mechanism is input; a structure type input field 176 to which the type of structure is input; a control type input field 177 to which a control type is input; a load mass input field 179 to which load mass is input; a stroke input field 179 to which a stroke is input; and a bearing type input field 180 to which the type of bearing is input.

The type of drive shaft, such as a rotation shaft, a linear shaft, and a parallel link shaft, is input to the drive-shaft type input field 171. The number of actuators used in each drive shaft is input to the actuator number input field 172. For a shaft such as a tandem shaft that uses a plurality of actuators to drive one drive shaft, a value of two or greater is set as the number of actuators. The type of guide mechanism, such as a linear ball guide, a linear roller guide, a sliding guide, a needle roller guide, a V-groove roller guide, an aerostatic guide, and a hydrostatic guide, is input to the guide-mechanism type input field 173.

The type of power transmission mechanism, such as a direct type, which has no power transmission mechanism, a ball screw, an OSB preload ball screw, an offset preload ball screw, a rack and pinion type, and a worm gear, is input to the power-transmission-mechanism type input field 174. The type of speed reduction mechanism, such as no speed reduction mechanism and gear ratio 5:1, is input to the speed-reduction-mechanism type input field 175. The type of actuator, such as a synchronous motor, an interior permanent magnet (IPM) motor, an induction motor, a linear motor, a piezoelectric device, a shaft motor, and a voice coil motor, is input to the actuator type input field 176. The type of control scheme, such as fully closed loop control, semi-closed loop control, and duel feedback control, is input to the control type input field 177. Load mass is input to the load mass input field 178, and a stroke is input to the stroke input field 179. The type of bearing, such as a single anchor type, a double anchor type, an angular contact type, and a deep groove ball, is input to the bearing type input field 180.

Any method may be used as an input method for each of the input fields; each of the input fields may be set to allow a numerical value or a text to be input directly; alternatively, a method may be used in which a pull-down menu or the like is used to allow an operator to make a selection from a plurality of options.

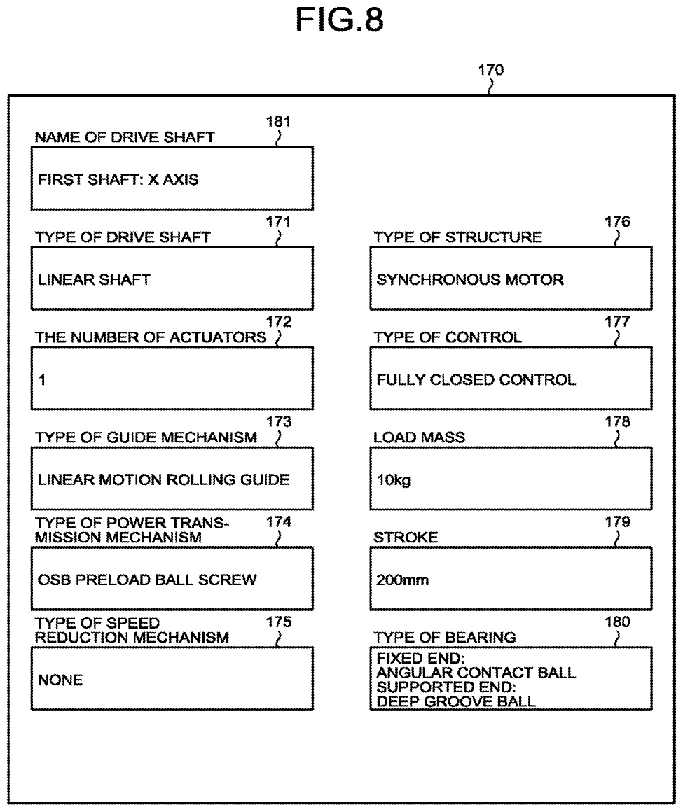

FIG. 8 is a diagram illustrating an example of the input screen 170 to which an operator has input the drive shaft parameters Cd that correspond to the machine apparatus 5 illustrated in FIG. 3.

While one or more of the type of machine of the machine apparatus, the placement location of a drive shaft, the number of drive shafts, the type of structure, machine dimensions, and machine mass can be used as the structure parameter Cm, the structure parameter Cm is not limited to these parameters. While one or more of the type of drive shaft, the number of actuators, the type of guide mechanism, the type of power transmission mechanism, the type of structure, the type of control, load mass, and a stroke can be used as the drive shaft parameter Cd, the drive shaft parameter Cd is not limited to these parameters.

As described above, the parameter input unit 11 receives the structure parameters and the drive shaft parameters Cd and then notifies the adjustment function selection unit 12 of the structure parameters Cm and the drive shaft parameters Cd that are received, which are input parameters. The adjustment function selection unit 12 selects a control parameter to be adjusted on the basis of the input parameters.

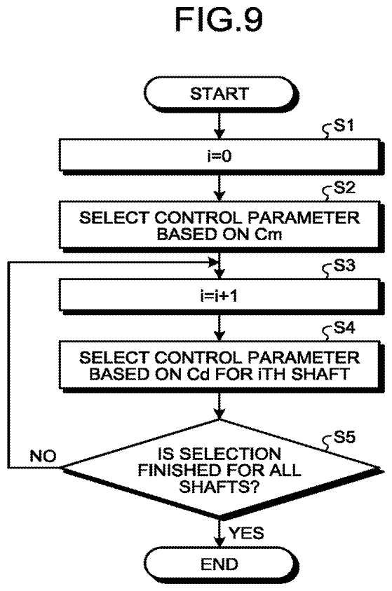

FIG. 9 is a flowchart illustrating an example procedure of control parameter selection processing in the adjustment function selection unit 12. First, the adjustment function selection unit 12 initializes i that is a variable indicative of a drive shaft to 0 (step S1). The adjustment function selection unit 12 then selects a control parameter to be used commonly in the machine apparatus 5 on the basis of the structure parameters Cm out of input parameters (step S2). Specifically, the adjustment function selection unit 12 selects a control parameter to be used commonly in the machine apparatus 5 on the basis of the structure parameters Cm out of input parameters and the control parameter selection information stored in the storage unit 14.

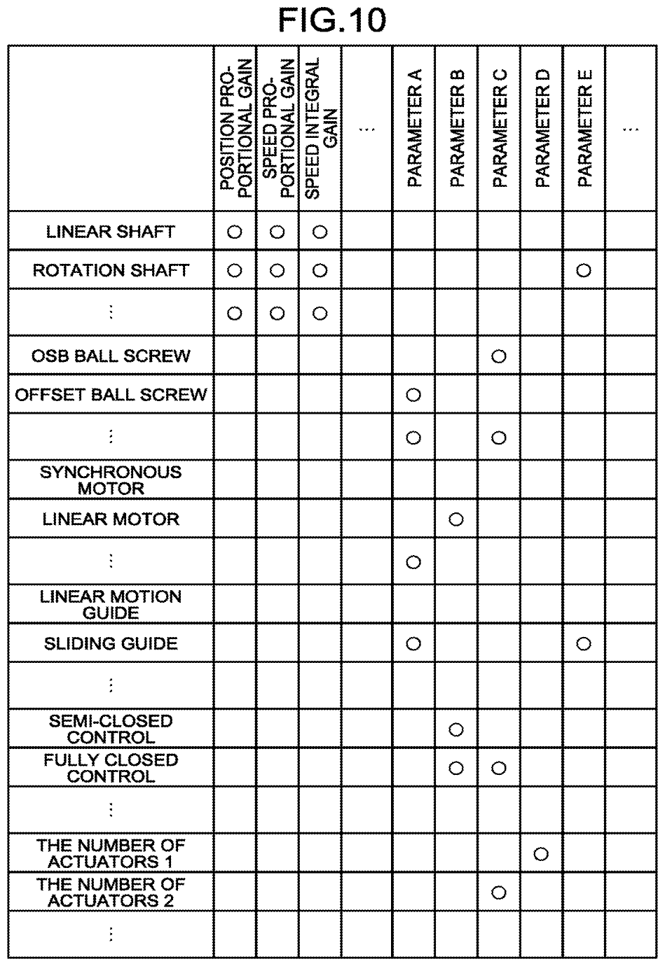

FIG. 10 is a diagram illustrating an example of the control parameter selection information according to the first embodiment. As illustrated in FIG. 10, the control parameter selection information is information in a matrix; in an example illustrated in FIG. 10, the structure parameters Cm and the drive shaft parameters Cd are indicated in a vertical direction and control parameters are indicated in a horizontal direction. In FIG. 10, a control parameter to be selected is marked with a circle for each piece of information input as the structure parameters Cm and the drive shaft parameters Cd.

With reference back to FIG. 9, the adjustment function selection unit 12 assumes i=i+1 (step S3) and selects a control parameter for an ith shaft on the basis of the drive shaft parameters Cd, out of the input parameters, that corresponds to the ith shaft (step S4). Specifically, the adjustment function selection unit 12 selects a control parameter on the basis of the drive shaft parameters Cd, out of the input parameters, that correspond to the ith shaft. For example, if the information input as the drive shaft parameters Cd that correspond to the ith shaft includes a linear shaft, then, a position proportional gain, a speed proportional gain, and a speed integral gain are selected as control parameters.

Subsequently, the adjustment function selection unit 12 determines whether the control parameter selection is finished for all the shafts, that is, all the drive shafts (step S5) and, if the control parameter selection is finished for all the drive shafts (yes in step S5), finishes the control parameter selection processing. If there is a drive shaft for which the control parameter selection is not finished (no in step S5), the adjustment function selection unit 12 reverts back to step S3. A control parameter that is selected in the processing described above is a control parameter to be adjusted. By determining a control parameter to be adjusted, a function to be activated is selected from the functions achievable by a control apparatus that numerically controls the machine apparatus 5, that is, the command-value generation unit 4 and the servo control unit 3.

The numbers of structure parameters Cm and drive shaft parameters Cd and the number of control parameters included in the control parameter selection information may be rendered changeable. When the numbers of structure parameters Cm and drive shaft parameters Cd and the number of control parameters included in the control parameter selection information are changed, the control parameter adjustment apparatus 1a changes the content of the input screen 70 and the input screen 170 described above in accordance with the change.

Control parameter adjustment processing in the adjustment execution unit 13 is described next. The adjustment execution unit 13 performs adjustment of control parameters that are selected by the adjustment function selection unit 12. As for the sequence of adjusting the control parameters, priority of adjustment may be assigned to all the control parameters in advance, or an operator may be enabled to set the priority for all the control parameters via the input device 45. The adjustment execution unit 13 adjusts the control parameters in accordance with the priority of the control parameters.

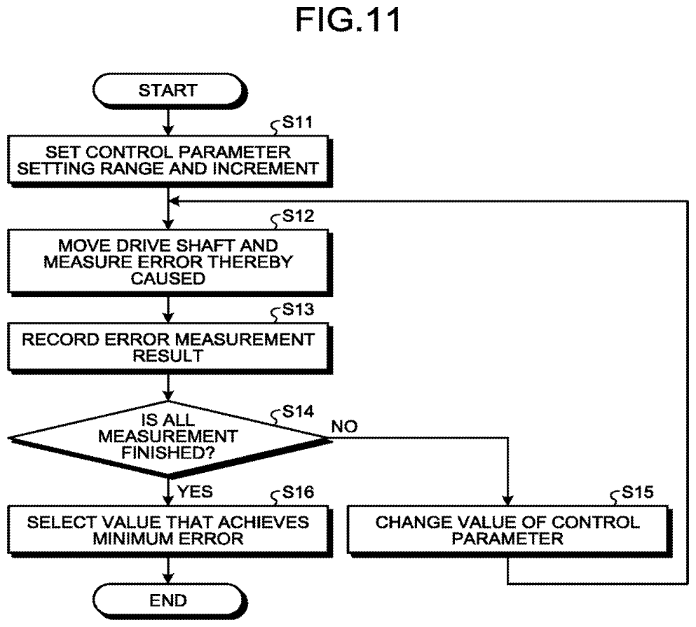

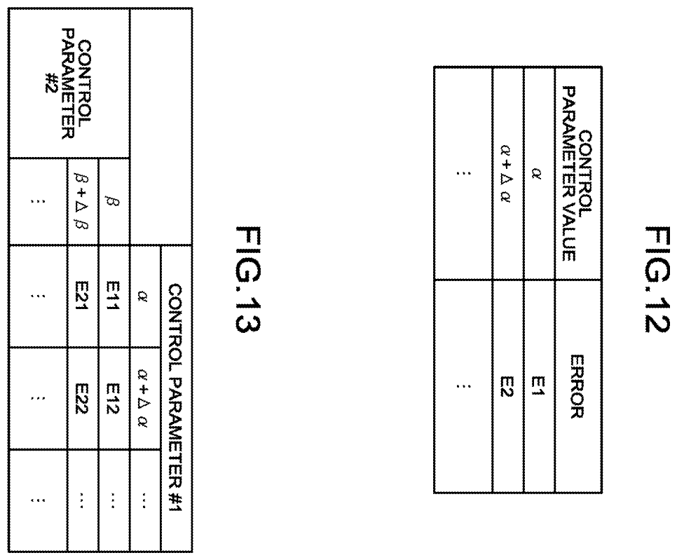

FIG. 11 is a flowchart illustrating an example procedure of control parameter adjustment processing in the adjustment execution unit 13. First, the adjustment execution unit 13 sets a control parameter setting range and an increment for a control parameter to be adjusted (step S11). The control parameter setting range and the increment may be set for each control parameter in advance or may be set by an operator via the input device 45.

The adjustment execution unit 13 determines a value of the control parameter on the basis of the setting range and the increment of the control parameter, executes control in accordance with the determined control parameter value to cause a drive shaft to move, and measures an error thereby caused (step S12). Specifically, the adjustment execution unit 13 has a list of operation program patterns that each correspond to a control parameter to be adjusted and determines the operation program Xc to be used for the adjustment in accordance with the determined control parameter. The adjustment execution unit 13 then transmits to the command-value generation unit 4 the operation program Xc that is determined and a parameter Pc that is a control parameter related to command generation out of the determined control parameters. The adjustment execution unit 13 also transmits to the servo control unit 3 the control parameter Ps that is a control parameter related to servo control out of the determined control parameters. The operation program Xc may be set in advance for each of the control parameters to be adjusted or set by an operator via the input device 45 for each of the control parameters to be adjusted. The command-value generation unit 4 is operated on the basis of the operation program Xc and the parameter Pc that are received, and the parameter setting unit 35 of the servo control unit 3 sets the parameter Ps that is received in each of corresponding units. The error transmission unit 36 of the servo control unit 3 acquires an error that is a difference between a command value and an actual value from each of the corresponding units and transmits the error measurement result to the control parameter adjustment apparatus 1a. An error is measured in this manner. When the quadrant glitch quantity, the overshoot quantity, or the like is used as the error Dm, the servo control unit 3 calculates the quadrant glitch quantity, the overshoot quantity, or the like or transmits information necessary for the calculation. For example, the position control unit 31 may calculate the quadrant glitch quantity and output the result to the error transmission unit 36; alternatively, the position control unit 31 may output time-series data of command values and actual positions, which is information necessary for the calculation of the quadrant glitch quantity, to the error transmission unit 36. The error transmission unit 36 transmits errors calculated by these units to the control parameter adjustment apparatus 1a. When the information necessary for the calculation of an error is transmitted, the control parameter adjustment apparatus 1a calculates the error on the basis of the information transmitted.

Subsequently, the adjustment execution unit 13 records the control parameter value determined in step S12 in association with the error measurement result in the storage unit 14 as measurement information (step S13). The adjustment execution unit 13 then determines whether or not all the measurements are finished for the control parameter in the setting range set in step S11 (step S14) and, if the measurement is not finished (no in step S14), changes the value of the control parameter (step S15) and performs again step S12 and the following steps.

If the adjustment execution unit 13 determines that all the measurements are finished for the control parameter in the setting range set in step S11 (yes in step S14), the adjustment execution unit 13 selects a value of the control parameter that achieves a minimum error on the basis of the recorded measurement information (step S16) and ends the parameter adjustment processing.

FIG. 12 is a diagram illustrating an example of the measurement information recorded in step S13. As illustrated in FIG. 12, the adjustment execution unit 13 records a control parameter value determined in step S12 and the measurement result, which is an error, received from the servo control unit 3. In FIG. 12, α represents a minimum value in the setting range of a control parameter set in step S11, and Δα represents an increment. E1 represents an error that is recorded in step S13 performed for the first time in the flowchart illustrated in FIG. 11. E2 represents an error that is recorded in step S13 performed for the second time via step S15 in the flowchart illustrated in FIG. 11. In a similar manner, every time step S13 is performed, a control parameter value determined in step S12 and an error are added to the measurement information. The adjustment execution unit 13 references this measurement information when selecting in step S16 a control parameter value that achieves a minimum error. As described above, the adjustment execution unit 13 executes the control parameter adjustment on the basis of information acquired from the servo control unit 3, which is a control apparatus.

While errors are measured in step S12 in a sequence starting from the minimum value in the setting range of a control parameter in the example illustrated here, errors may be measured in step S12 in a sequence starting from a maximum value in the setting range of the control parameter. In this case, errors are measured in step S12 by reducing the control parameter value from the maximum value by a certain quantity.

When a control parameter value to be used is determined, the adjustment execution unit 13 transmits the determined control parameter value to at least one of the command-value generation unit 4 and the servo control unit 3. A control parameter value that is related to the generation of a command value is transmitted to the command-value generation unit 4; a control parameter value that is related to the servo control is transmitted to the command-value generation unit 4; and a control parameter value that is related to both the generation of a command value and the servo control is transmitted to the command-value generation unit 4 and the servo control unit 3.

The adjustment execution unit 13 executes the control parameter adjustment processing described above using FIG. 11 for each control parameter selected in the control parameter selection processing. A control parameter may have a different optimal value depending on a set value of another control parameter. That is, two or more control parameters may interfere with each other. In such cases, an identical value is set as the adjustment priority of such two or more control parameters that interfere with each other, and the adjustment execution unit 13 adjusts these two or more control parameters together.

When, for example, two control parameters, i.e., a control parameter #1 and a control parameter #2, are adjusted together, the adjustment execution unit 13 determines the setting ranges and increments for both the control parameter #1 and the control parameter #2 in step S11. Then, errors are measured in a matrix while the values of the control parameter #1 and the control parameter #2 are changed.

FIG. 13 is a diagram illustrating an example of the measurement information when the control parameter #1 and the control parameter #2 are adjusted together. In FIG. 13, α represents a minimum value in the setting range of the control parameter #1 set in step S11 and Δα represents the increment of the control parameter #1. In FIG. 13, β represents a minimum value in the setting range of the control parameter #2 set in step S11 and Δβ represents the increment of the control parameter #2. E11, E12, and the like represent errors that correspond to the values of the control parameter #1 and the control parameter #2. For example, E11 represents an error that is recorded in step S13 when the value of the control parameter #1 is set to α and the value of the control parameter #2 is set to β. In this manner, when two control parameters are adjusted together, the measurement information is provided as information in a matrix. The adjustment execution unit 13 references this measurement information in the matrix when selecting in step S16 the values of the control parameter #1 and the control parameter #2 that achieve a minimum error.

When three or more control parameters are adjusted together, the adjustment execution unit 13 similarly changes the value of each of the three or more control parameters to obtain the measurement information in a multidimensional matrix and determines a value of each of the control parameters on the basis of the measurement information.

As described above, the control parameter adjustment apparatus 1a according to the present embodiment has the control parameter selection information, which indicates the correspondence between the structure parameter Cm and the drive shaft parameter Cd and a control parameter, and is configured to select and set a control parameter to be adjusted on the basis the structure parameter Cm and the drive shaft parameter Cd that are input and the control parameter selection information. When an operator sets a control parameter to be adjusted, the operator is thus merely required to input the structure parameter Cm and the drive shaft parameter Cd and does not need to select a control parameter to be adjusted. Operators including unskilled operators are thereby enabled to appropriately set a control parameter to be adjusted in a control apparatus that has a plurality of functions.

Some control parameters interfere with each other. If functions that include control parameters that interfere with each other are used simultaneously out of a plurality of functions achieved by control apparatuses that numerically control the machine apparatus 5, that is, the command-value generation unit 4 and the servo control unit 3, a control parameter that is set to satisfy certain performance may cause degradation in another function. In the present embodiment, control parameters that interfere with each other are adjusted together to set control parameter values that achieve a minimum error, and degradation of performance is thus inhibited.

When control parameters that correspond to different functions and have effects interfering with each other are adjusted separately for each of the functions, the adjustment of the control parameters often has to be redone. An optimal value of a parameter in certain control being affected by other control is referred to as interference of effects. For example, a set value of a control parameter in feedback control may affect an optimal friction correction control parameter. When, for example, a position loop gain, a speed loop gain, an integral gain, or a disturbance observer is used, an observer gain, cutoff frequency, or the like is affected due to interference of other functions. If the machine structure is determined, the friction characteristic unique to the machine structure is determined, and thus, which one to use out of a plurality of friction correction functions is uniquely determined; however, an optimal friction correction parameter varies depending on a set value of the position loop gain, a set value of the disturbance observer, and the like. In the present embodiment, control parameters that interfere with each other are adjusted together to set control parameter values that achieve a minimum error; thus, redoing the adjustment of the control parameters can be inhibited.

Additionally, an operator may select a control parameter to be adjusted in accordance with the personal preference such as ease of adjustment. In the present embodiment, a control parameter is selected on the basis of the structure parameter Cm and the drive shaft parameter Cd and a control parameter, which are objective information, and the control parameter selection information, which is predefined; thus, a control parameter that is physically appropriate, that is, a control parameter that is appropriate for satisfying the performance of the machine apparatus 5 can be selected as a control parameter to be adjusted.

Additionally, in the present embodiment, control parameters are not set for each function; instead, control parameters are selected in accordance with the structure parameter Cm and the drive shaft parameter Cd, and control parameters that overlap between functions are thus adjusted in one process. Time taken for the adjustment in the present embodiment is thus shorter than when a control parameter is adjusted for each function. Moreover, similar functions that yield similar effects can be separated in the present embodiment; thus, an effect is produced in which the adjustment is completed with higher accuracy.

### Second Embodiment

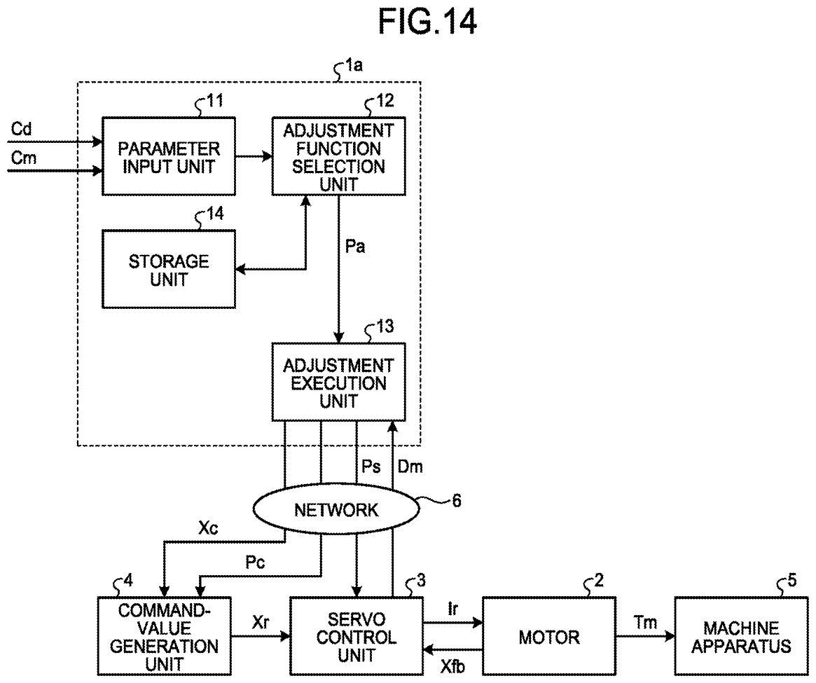

FIG. 14 is a diagram illustrating an example of connection between the control parameter adjustment apparatus 1a according to a second embodiment of the present invention and the command-value generation unit 4 and the servo control unit 3. Configurations of the control parameter adjustment apparatus 1a, the servo control unit 3, the command-value generation unit 4, and the machine apparatus 5 are similar to those of the first embodiment. In the present embodiment, the control parameter adjustment apparatus 1a is connected to the command-value generation unit 4 and the machine apparatus 5 via a network 6. A difference from the first embodiment is mainly described below and duplicate description is omitted.

The control parameter adjustment apparatus 1a according to the present embodiment may be placed in a location physically away from the machine apparatus 5. For example, the machine apparatus 5, the motor 2, the servo control unit 3, and the command-value generation unit 4 may be placed in a manufacturing area in a plant, whereas the control parameter adjustment apparatus 1a may be implemented in a server computer that is placed in a server room of the plant and that is connected by the network 6, which is an in-plant network. The command-value generation unit 4 may be implemented in a computer that is connected by the network 6, instead of being placed in manufacturing area of a plant.

The network 6 may be an Internet connection network. In this case, the control parameter adjustment apparatus 1a may be implemented in a cloud computer.

In the present embodiment, the communication device 44 of the control parameter adjustment apparatus 1a performs communication processing that corresponds to a communication protocol in the network 6. Functions of the communication device 44 enable the adjustment execution unit 13 to transmit a control parameter to the command-value generation unit 4 and the servo control unit 3 and to receive an error, in a similar manner to the first embodiment.

In the present embodiment, since the control parameter adjustment apparatus 1a can be placed in a server room or the like, the control parameter adjustment apparatus 1a can control a plurality of control systems. A control system includes a machine apparatus and a control apparatus that controls the machine apparatus; in an exemplary configuration illustrated in FIG. 14, the command-value generation unit 4, the servo control unit 3 the motor 2, and the machine apparatus 5 configure a control system.

When the control parameter adjustment apparatus 1a controls a plurality of control systems, the control parameter adjustment apparatus 1a has the control parameter selection information for each of the control systems. When receiving the input of the structure parameter Cm, the control parameter adjustment apparatus 1a adds an input field in the input screen 70 illustrated in FIG. 5 for identification information, such as a unique name of a machine apparatus and machine model number, for identifying a machine apparatus that configures a control system. When receiving the input of the drive shaft parameter Cd, the control parameter adjustment apparatus 1a additionally displays identification information for identifying the machine apparatus in the input screens 170 illustrated in FIG. 7.

As described above, the control parameter adjustment apparatus 1a according to the second embodiment enables an operator in a remote location to adjust a control parameter for machine apparatus 5 with ease in a similar manner to the first embodiment. The control parameter adjustment apparatus 1a according to the second embodiment also produces an effect of enabling selection of an appropriate combination of control parameters for a unique machine and a new component.

### Third Embodiment

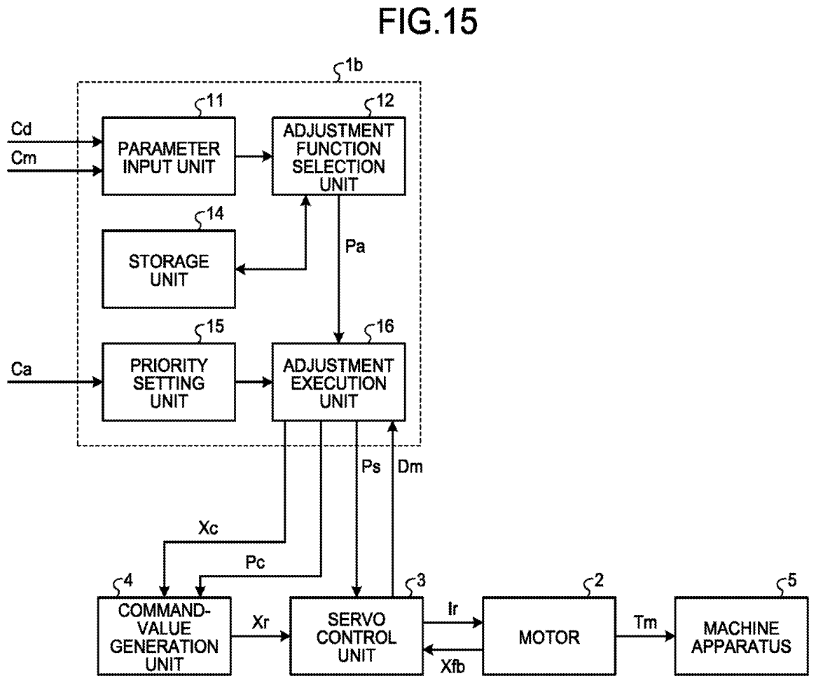

FIG. 15 is a diagram illustrating an exemplary configuration of a control parameter adjustment apparatus according to a third embodiment of the present invention. The servo control unit 3, the command-value generation unit 4, and the machine apparatus 5, which are to be controlled by a control parameter adjustment apparatus 1b, are similar to those in the first embodiment.

As illustrated in FIG. 15, the control parameter adjustment apparatus 1b according to the third embodiment is similar to the control parameter adjustment apparatus 1a according to the first embodiment, except that the control parameter adjustment apparatus 1b includes a priority setting unit 15, which is not included in the control parameter adjustment apparatus 1a according to the first embodiment, and an adjustment execution unit 16 in place of the adjustment execution unit 13. Components having functions similar to those in the first embodiment are denoted by symbols identical with those in the first embodiment and duplicate description is omitted below. A difference from the first embodiment is mainly described below.

The priority setting unit 15 and the adjustment execution unit 16 according to the present embodiment are achieved by the arithmetic unit 41 illustrated in FIG. 2 executing a program stored in the storage device 43. The priority setting unit 15 is achieved by using also the storage device 43.

In the present embodiment, the priority setting unit 15 retains a numerical target and priority for each item of performance of the machine apparatus 5, that is, for each performance item, as target information in the storage device 43, and the adjustment execution unit 16 adjusts a control parameter in accordance with the priority. In FIG. 15, Ca denotes the priority. The performance item is, for example, any one or more of the quadrant glitch quantity, the overshoot quantity, trajectory precision, maximum acceleration, a frequency response band, a position deviation, a moving time, a vibration amplitude, and an energy consumption.

When the performance that the machine apparatus 5 achieves is higher than target performance, there is no need to adjust a control parameter. In the present embodiment, the priority setting unit 15 sets a numerical target to be achieved in the adjustment execution unit 16 for each performance item. After the adjustment function selection unit 12 performs the control parameter selection processing described in the first embodiment, the adjustment execution unit 16 sets a value of a control parameter to be adjusted and then performs steps S12 and S13 in the control parameter adjustment processing illustrated in FIG. 11. That is, an error is measured once for each of all the control parameters to be adjusted. A value of a control parameter to be set here is any value, for example, within a setting range set in step S11 in the first embodiment.

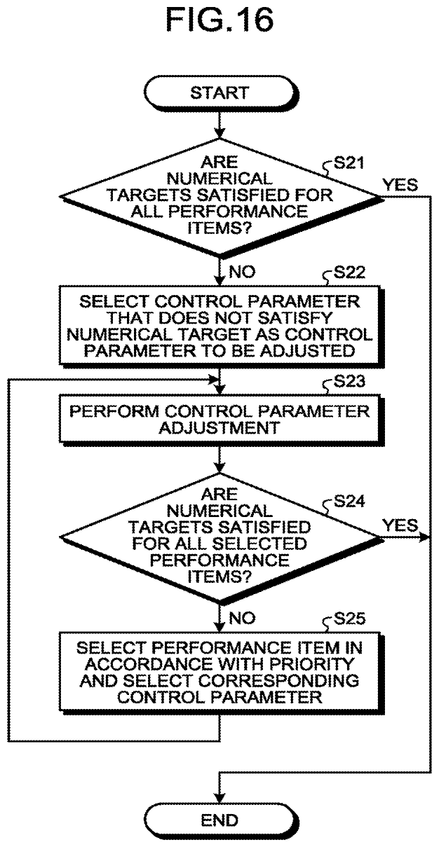

After an error is measured once for each of all the control parameters to be adjusted, the adjustment execution unit 16 performs control parameter adjustment processing on the basis of the numerical targets and the priority. FIG. 16 is a flowchart illustrating an example procedure of the control parameter adjustment processing in the adjustment execution unit 16 according to the third embodiment. The adjustment execution unit 16 determines whether or not numerical targets are satisfied for all the performance items on the basis of the error measurement results (step S21). Specifically, the adjustment execution unit 16 makes a comparison between an error measurement result and a numerical target for each performance item on the basis of the target information received from the priority setting unit 15 and determines whether or not each numerical target is satisfied. As used herein, all the performance items refer to performance items that correspond to the control parameters selected in the control parameter selection processing described in the first embodiment.

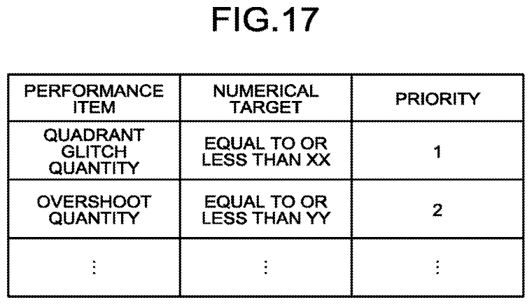

FIG. 17 is a diagram illustrating an example of the target information. As illustrated in FIG. 17, the tar information includes a numerical target and priority for each performance item. The target information may be set in advance or input by an operator via the input device 45. The performance items and the control parameters may have one-to-one correspondence, many-to-one correspondence, or one-to-many correspondence and the correspondence between the performance items and the control parameters is retained in the storage unit 14 separately from the target information. A control parameter field may be added to the target information, and the control parameter adjustment apparatus 1b may manage a control parameter that corresponds to each performance item using the target information.

If all the numerical targets are satisfied (yes in step S21), the adjustment execution unit 16 ends the parameter adjustment processing. If there is a performance item for which a numerical target is not satisfied (no in step S21), a control parameter that does not satisfy the numerical target, that is, a control parameter that corresponds to the performance item for which the numerical target is not satisfied is selected as a control parameter to be adjusted (step S22).

Then, the control parameter adjustment is performed on the selected control parameter (step S23). The selected control parameter in step S23 that is performed for the first time is a control parameter that is selected in step S22, and the selected control parameter in step S23 that is performed for the second time or later is a control parameter that is selected in step S25, which is to be described below. Specifically, the processing illustrated in FIG. 11 in the first embodiment is performed for each selected control parameter in step S23.

The adjustment execution unit 16 then determines whether or not the numerical targets are satisfied for all the selected performance items (step S24). A selected performance item here refers to a performance item selected in step S25, which is described below, on the basis of the priority. All the selected performance items in step S24 that is performed for the first time are the same as all the performance items in step S21 because step S25 is not performed yet. If the numerical targets for all the selected performance items are satisfied (yes in step S24), the adjustment execution unit 16 ends the parameter adjustment processing.

If a numerical target for any of the selected performance items is not satisfied (no in step S24), the adjustment execution unit 16 selects a performance item in accordance with the priority and selects a corresponding control parameter (step S25), and performs the processing in step S23 and the following steps again. Specifically, the adjustment execution unit 16 selects a performance item having high priority. If, for example, the priority is set in such a manner that the numerical value 1 represents the highest priority and, as the value increases, the priority decreases, and if there are a performance item having priority 1, a performance item having priority 2, and a performance item having priority 3, the adjustment execution unit 16 selects, in step S25, the performance item having the priority 1 and the performance item having the priority 2. While a performance item having the lowest priority is not selected in this example, a performance item selecting method based on priority is not limited to this example.

The control parameter adjustment processing may be configured to end if the control parameter adjustment in step S23 is performed for certain times or more and the control parameter adjustment processing is still not completed.

As described above, the adjustment execution unit 16 according to the present embodiment executes the control parameter adjustment on the basis of a numerical target set for each performance item. If there is a performance item for which a numerical target is not satisfied, the adjustment execution unit 16 selects a control parameter to be adjusted on the basis of the priority set for each performance item. While the adjustment execution unit 16 selects a control parameter to be adjusted on the basis of the priority set for each performance item in the example described above, this is not a limitation; the adjustment function selection unit 12 may select a control parameter to be adjusted on the basis of the priority set for each performance item. In this case, the priority is input to the adjustment function selection unit 12 in place of the adjustment execution unit 16. If the adjustment execution unit 16 determines in step S24 that there are numerical targets that are not satisfied, the adjustment execution unit 16 notifies the adjustment function selection unit 12 of the corresponding performance items, and the adjustment function selection unit 12 selects from the indicated performance items a performance item in accordance with the priority and notifies the adjustment execution unit 16 of a control parameter that corresponds to the selected performance item. In this manner, the adjustment execution unit 16 executes the control parameter adjustment on the basis of a numerical target set for each performance item.

Performing the processing described above can sequentially reduce control parameters to be adjusted in accordance with the priority, if there is a numerical value item for which a numerical target is not satisfied after the control parameter adjustment is performed. There may be a case where some numerical targets remain unsatisfied for some performance items depending on the conditions of the machine apparatus, regardless of how many times control parameters are adjusted. In such a case, an attempt to continue the parameter adjustment until the numerical targets are satisfied for all the performance items results in unfinished parameter adjustment processing. Since performance items of higher priority are selected on the basis of the priority, the parameter adjustment processing can be performed efficiently in the present embodiment.

If one of performance targets that have a tradeoff relationship with each other, such as accuracy and speed, has unsatisfied target performance, corresponding control parameters cannot be adjusted without a guideline that indicates which performance should have priority. Since a performance item of higher priority is selected in the present embodiment, the parameter adjustment processing can be performed also in such cases. For a control parameter that corresponds to a performance item that is not selected, it is satisfactory if a value that achieves the minimum error is set as in the case with the first embodiment.

Presence of control parameters that produce similar effects and control parameters that have interfering effects may prevent an optimal control parameter from being uniquely determined and thus an adjustment task may not end. Since a performance item of higher priority is selected in the present embodiment, the parameter adjustment processing can be performed also in such cases.

It is difficult to completely model a physical phenomenon that occurs in the real world; therefore, there is a limit on the level of performance achievable by a correction function performed by each control apparatus. If, for example, required performance exceeds reproducibility of a machine apparatus or an error is caused by an unknown physical phenomenon, target performance is not achieved regardless of how many times a control parameter of a function of a control apparatus is adjusted. In such cases, it is necessary to search for a combination that achieves the required performance as much as possible by using a function of the control apparatus It is not easy, however, for an operator to know the limit of the function of the control apparatus, and thus, the operator has difficulty in determining how far the search should be done. In the present embodiment, a performance item is selected in accordance with the priority as long as the priority is set for each performance item as described above; thus, a control parameter can be set efficiently.

While the control parameter adjustment apparatus 1b is used in the configuration described in the first embodiment in the example described in the present embodiment, the control parameter adjustment apparatus 1b may be connected to the command-value generation unit 4 and the servo control unit 3 via a network as in the case with the second embodiment.

### Fourth Embodiment

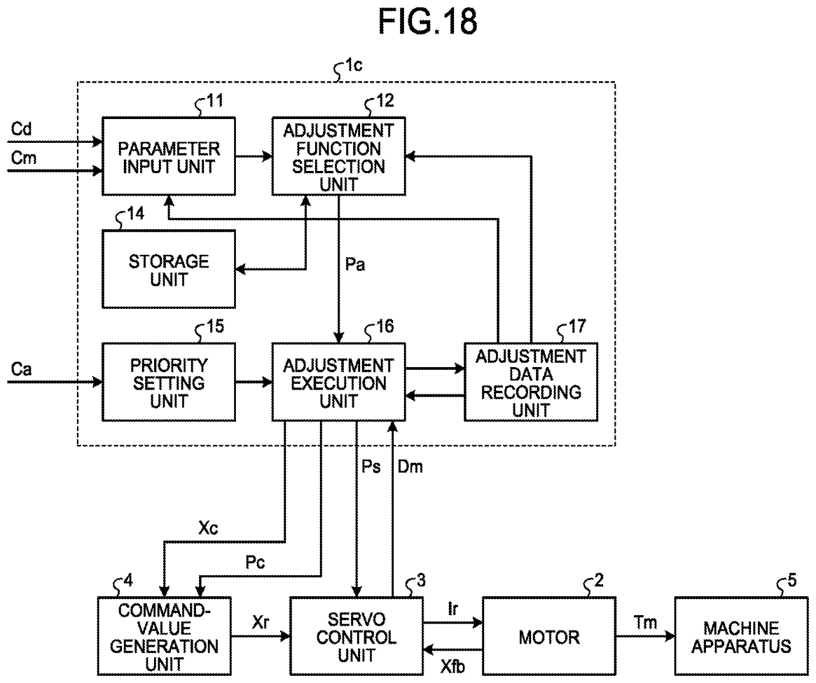

FIG. 18 is a diagram illustrating an exemplary configuration of a control parameter adjustment apparatus according to a fourth embodiment of the present invention. The servo control unit 3, the command-value generation unit 4, and the machine apparatus 5, which are to be controlled by a control parameter adjustment apparatus 1c according to the fourth embodiment, are similar to those in the first embodiment.

As illustrated in FIG. 18, the control parameter adjustment apparatus 1c according to the fourth embodiment is similar to the control parameter adjustment apparatus 1b according to the third embodiment, except that the control parameter adjustment apparatus 1c includes an adjustment data recording unit 17, which is not included in the control parameter adjustment apparatus 1b according to the third embodiment, and is configured to enable the parameter input unit 11, the adjustment function selection unit 12, and the adjustment execution unit 16 to reference information recorded by the adjustment data recording unit 17. Components having functions similar to those in the third embodiment are denoted by symbols identical with those in the third embodiment and duplicate description is omitted below. A difference from the third embodiment is mainly described below.

The adjustment data recording unit 17 is achieved by the arithmetic unit 41 illustrated in FIG. 2 executing a program stored in the storage device 43. The adjustment data recording unit 17 is achieved by using also the storage device 43.

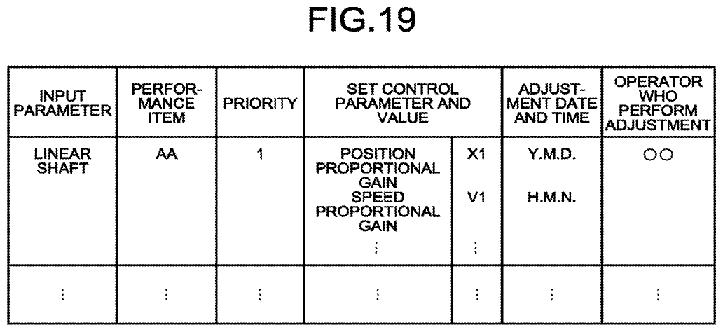

After the control parameter adjustment described in the third embodiment is completed, the adjustment data recording unit 17 records in the storage device 43 information on an input parameter, a performance item, priority, a control parameter finally set and its value, an adjustment date and time, and the name of an operator who performed the adjustment. The adjustment data recording unit 17 is a recording unit that records at least one of a value of a control parameter that is set and a design parameter that is received after the control parameter adjustment is performed. FIG. 19 is a diagram illustrating an example of information recorded by the adjustment data recording unit 17. A part of the information, in place of all the information, may be recorded. The input parameter is a design parameter that is received by the parameter input unit 11.

The input parameter, out of the information recorded by the adjustment data recording unit 17, may be displayed on the input screen 70 and the input screens 170 as an initial value when subsequent parameter adjustment is performed. The adjustment execution unit 16 may set a value of a control parameter for the measurement of an error by using the information recorded by the adjustment data recording unit 17.

Additionally, data recorded by the adjustment data recording unit 17 of another control parameter adjustment apparatus 1c may be acquired via a network.

The control parameter adjustment apparatus 1c according to the fourth embodiment described above enables an operator to use the information that is already saved and thereby perform the control parameter adjustment efficiently also when something about the structure parameter Cm or the drive shaft parameter Cd is unclear. The control parameter adjustment apparatus 1c according to the fourth embodiment also produces an effect of enabling a reduction in the time taken to input the structure parameter Cm and the drive shaft parameter Cd and a reduction in the number of setting errors.

The adjustment data recording unit 17 may be added to the control parameter adjustment apparatus 1a according to the first or second embodiment in a similar manner.

### Fifth Embodiment

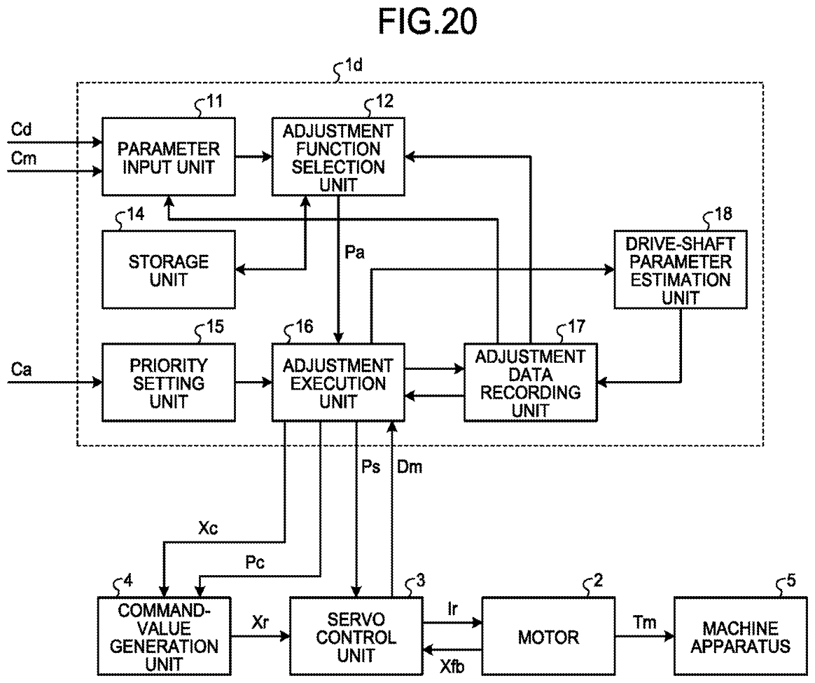

FIG. 20 is a diagram illustrating an exemplary configuration of a control parameter adjustment apparatus according to a fifth embodiment of the present invention. The servo control unit 3, the command-value generation unit 4, and the machine apparatus 5, which are to be controlled by a control parameter adjustment apparatus 1d according to the fifth embodiment, are similar to those in the first embodiment.

As illustrated in FIG. 20, the control parameter adjustment apparatus 1d according to the fifth embodiment is similar to the control parameter adjustment apparatus 1c according to the fourth embodiment, except that the control parameter adjustment apparatus 1d includes a drive-shaft parameter estimation unit 18, which is not included in the control parameter adjustment apparatus 1c according to the fourth embodiment. Components having functions similar to those in the fourth embodiment are denoted by symbols identical with those in the fourth embodiment and duplicate description is omitted below. A difference from the fourth embodiment is mainly described below.

The drive-shaft parameter estimation unit 18 is achieved by the arithmetic unit 41 illustrated in FIG. 2 executing a program stored in the storage device 43.

When there is an unknown structure parameter Cm or an unknown drive shaft parameter Cd that is not recognized by an operator, that is, a parameter that is not input, the control parameter adjustment apparatus 1d according to the fifth embodiment accepts an instruction to perform a parameter estimating operation from the operator operating on the input device 45. Then, the drive-shaft parameter estimation unit 18 performs the parameter estimating operation to estimate an unknown parameter on the basis of component estimation information retained in the storage unit 14 and data acquired from the servo control unit 3 by the adjustment execution unit 16.

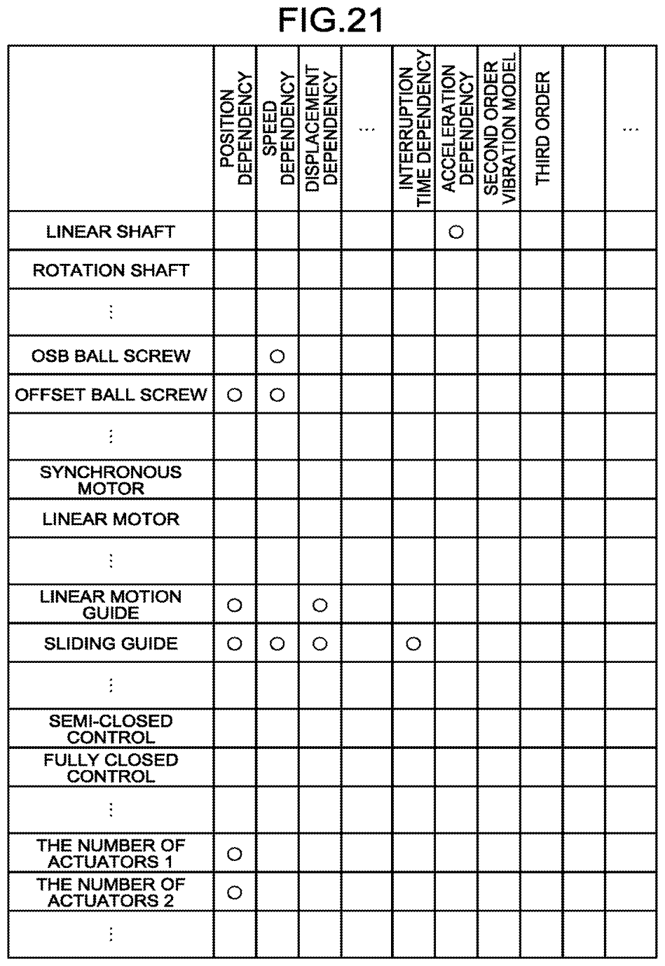

The component estimation information may be set in advance or input by an operator. FIG. 21 is a diagram illustrating an example of the component estimation information. The component estimation information is information in a matrix that indicates correspondence of the structure parameter Cm and the drive shaft parameter Cd to dependency of a parameter on a quantity of state. In an example illustrated in FIG. 21, the structure parameters Cm and the drive shaft parameters Cd are indicated in the vertical direction and dependency on a quantity of state is indicated in the horizontal direction.

As illustrated in FIG. 21, dependency on a quantity of state that a linear shaft, for example, corresponds to is acceleration dependency. When there is acceleration dependency, the drive-shaft parameter estimation unit 18 acquires various errors from the servo control unit 3 via the adjustment execution unit 16. The drive-shaft parameter estimation unit 18 then estimates the structure parameter Cm and the drive shaft parameter Cd on the basis of the acquired errors. Any method may be used by the drive-shaft parameter estimation unit 18 to estimate a parameter; for example, a method of estimating a parameter may be used in which a frequency response is calculated from a response of the motor 2 provided when a random signal or a sine sweep signal is input to the motor 2 and a vibration characteristic is determined by a subspace method or the like. Alternatively, a method of estimating a parameter may be used in which a friction characteristic is determined using the method of least squares from a graph of a motor current and a motor position. Alternatively, a friction parameter estimating method disclosed in Japanese Patent No. 5996127 may be used.

The drive-shaft parameter estimation unit 18 provides the result of the estimation to the adjustment data recording unit 17. The adjustment data recording unit 17 records the received result of the estimation in a similar manner to an input parameter in the fourth embodiment and provides the result of the estimation to the adjustment function selection unit 12. In this manner, the adjustment function selection unit 12 can select a control parameter by using the structure parameter Cm and the drive shaft parameter Cd that are input and the result of the estimation and by referencing the control parameter selection information, as in the case with the first to fourth embodiments. Subsequently, the adjustment of the control parameter is performed in a manner similar to that of the fourth embodiment.

As described above, the drive-shaft parameter estimation unit 18, which is a parameter estimating unit, estimates at least one of the structure parameter Cm and the drive shaft parameter Cd on the basis of information acquired from the servo control unit 3, which is a control apparatus.

In the control parameter adjustment apparatus 1d according to the fifth embodiment described above, the drive-shaft parameter estimation unit 18 estimates an unknown parameter that is not recognized by an operator. In this manner, the control parameter adjustment apparatus 1d according to the fifth embodiment can produce an effect similar to that of the fourth embodiment also when there is an unknown structure parameter Cm or an unknown drive shaft parameter Cd.

The drive-shaft parameter estimation unit 18 may be added to any of the control parameter adjustment apparatuses according to the first to third embodiments to estimate an unknown parameter in a similar manner.

### Sixth Embodiment

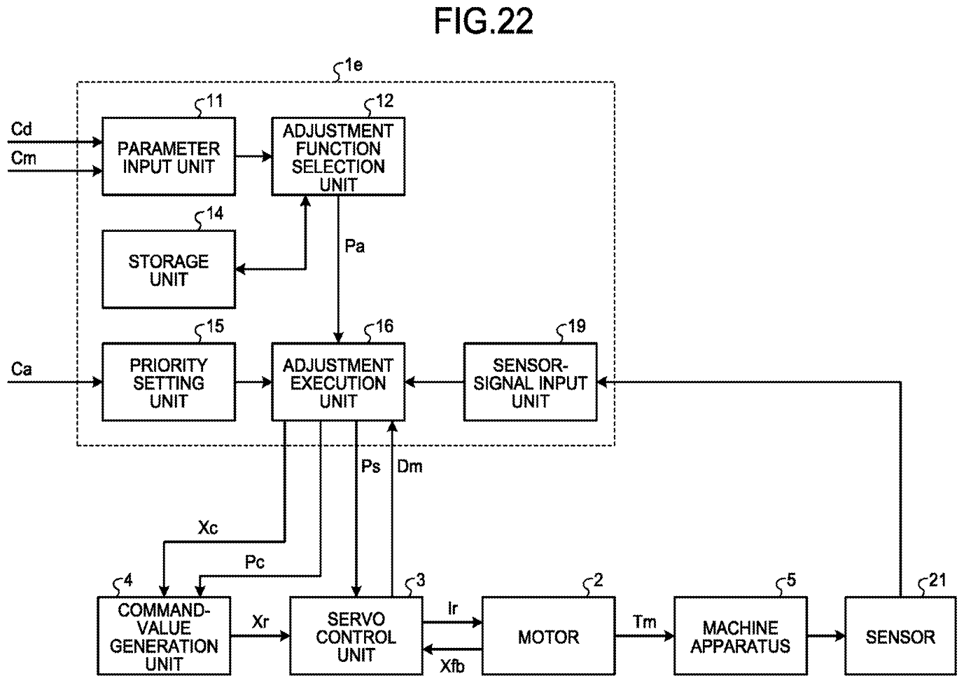

FIG. 22 is a diagram illustrating an exemplary configuration of a control parameter adjustment apparatus according to a sixth embodiment the present invention. The servo control unit 3, the command-value generation unit 4, and the machine apparatus 5, which are to be controlled by a control parameter adjustment apparatus 1e according to the sixth embodiment, are similar to those in the first embodiment. A sensor 21 is attached to the machine apparatus 5.

As illustrated in FIG. 22, the control parameter adjustment apparatus 1e according to the sixth embodiment is similar to the control parameter adjustment apparatus 1b according to the third embodiment, except that the control parameter adjustment apparatus 1e includes a sensor-signal input unit 19, which is not included in the control parameter adjustment apparatus 1b according to the third embodiment. Components having functions similar to those in the third embodiment are denoted by symbols identical with those in the third embodiment and duplicate description is omitted below. A difference from the third embodiment is mainly described below.

A signal of the sensor 21, which is attached to the machine apparatus 5, is input to the sensor-signal input unit 19. The sensor 21 measures a state of the machine apparatus 5. The sensor 21 is, for example, an acceleration sensor attached to the table or an end of a hand, which is to be controlled, a coordinate measuring machine that measures motion of an end of a tool, a laser interferometer, or a Doppler vibrometer. Some control parameters are for correcting a vibration or a positioning error at a position of a subject to be to be controlled. A signal controlled by the servo control unit 3 does not represent such errors directly. It is for this reason that a subject to be controlled needs to be measured directly to adjust a control parameter for correcting such errors. The sensor-signal input unit 19 in the present embodiment acquires information indicative of a vibration or a positioning error at a position of a subject to be controlled, which is measured by the sensor 21, or the like.

The adjustment execution unit 16 receives the result of measurement, which is an error of a subject to be controlled, from the sensor-signal input unit 19 and, on the basis of the result of the measurement, performs the parameter adjustment in a manner similar to that in the third embodiment.

The control parameter adjustment apparatus 1e according to the sixth embodiment described above produces an effect similar to that of the third embodiment and another effect of enabling adjustment of a control parameter that cannot be adjusted using just signal received from the servo control unit 3.

The sensor-signal input unit 19 may be added to the control parameter adjustment apparatus according to the first, second, fourth, or fifth embodiment to perform adjustment of a control parameter using the sensor 21, which is attached to the machine apparatus 5.

Note that the configurations described in the foregoing embodiments are examples of the present invention; combining the present invention with other publicly known techniques is possible, and partial omissions and modifications are possible without departing from the spirit of the present invention.

### REFERENCE SIGNS LIST

1a, 1b, 1c, 1d, 1e control parameter adjustment apparatus; 2 motor; 3 servo control unit; 4 command-value generation unit; 5 machine apparatus; 11 parameter input unit; 12 adjustment function selection unit; 13, 16 adjustment execution unit; 14 storage unit; 15 priority setting unit; 17 adjustment data recording unit; 18 drive-shaft parameter estimation unit; 19 sensor-signal input unit; 21 sensor; 30a, 30b adder-subtracter unit; 31 position control unit; 33 differentiation operation unit; 34 speed control unit; 35 parameter setting unit; 36 error transmission unit; 37 drive circuit.

1. A control parameter adjustment apparatus that adjusts a control parameter of a control apparatus that controls a machine apparatus that includes a drive shaft, the control parameter adjustment apparatus comprising:
a processor to execute a program; and
a memory to store the program which, when executed by the processor, performs processes of:
receiving an input of a design parameter that characterizes a property of the machine apparatus;
selecting a control parameter to be adjusted from control parameters that correspond to a function of the control apparatus on a basis of the design parameter received by the receiving; and
executing adjustment of the control parameter selected by the selecting.

2. The control parameter adjustment apparatus according to claim 1, wherein the design parameter includes at least one of a structure parameter that characterizes a structure of the machine apparatus and a drive shaft parameter that characterizes a component that configures the drive shaft in the machine apparatus.

3. The control parameter adjustment apparatus according to claim 2, wherein the structure parameter is one or more of a type of machine of the machine apparatus, a placement location of the drive shaft, the number of drive shafts, a type of structure, a machine dimension, and machine mass.

4. The control parameter adjustment apparatus according to claim 2, wherein the drive shaft parameter is one or more of a type of drive shaft, the number of actuators, a type of guide mechanism, a type of power transmission mechanism, a type of structure, a type of control, load mass, and a stroke.

5. The control parameter adjustment apparatus according to claim 1, wherein the executing includes executing adjustment of the control parameter on a basis of a numerical target set for each performance item.

6. The control parameter adjustment apparatus according to claim 1, wherein the program which, when executed by the processor, further performs a process of recording at least one of a value of a control parameter that is set and the received design parameter after adjustment of the control parameter is executed.

7. The control parameter adjustment apparatus according to claim 1, wherein the program which, when executed by the processor, further performs a process of estimating the design parameter on a basis of information acquired from the control apparatus.

8. The control parameter adjustment apparatus according to claim 1, wherein the control parameter adjustment apparatus is connected to the control apparatus via a network.

9. The control parameter adjustment apparatus according to claim 1, wherein the executing includes executing adjustment of the control parameter on a basis of information acquired from the control apparatus.

10. The control parameter adjustment apparatus according to claim 1, wherein the program which, when executed by the processor, further performs a process of acquiring a result of measurement performed by a sensor that measures a state of the machine apparatus, and
the executing includes executing adjustment of the control parameter using the result of the measurement.
